(19) United States
(12) Patent Application Publication
(10) Pub. No.: US 2023/0298102 A1
(43) Pub. Date: Sep. 21, 2023

(54) DEEP BILATERAL LEARNING AND FORECASTING IN QUANTITATIVE INVESTMENT

(71) Applicant: INTERNATIONAL BUSINESS MACHINES CORPORATION, ARMONK, NY (US)

(72) Inventor: Bo Wu, Cambridge, MA (US)

(21) Appl. No.: 17/655,000

(22) Filed: Mar. 16, 2022

(51) Int. Cl. G06Q 40/06

(52) U.S. Cl. CPC G06Q 40/06

(57) ABSTRACT

In a method for quantitative investment using a bilateral autotrading framework (BAF), a processor receives a market dataset comprising stock prices, constructs a time series input by applying cross-sectional rank forecasting to the market dataset, generates a bilateral indicator based on the time series input, predicts a rank of stock return based on the bilateral indicator, executing, by one or more processors, an adjustment of a position in a stock based on the rank of stock return.

### BACKGROUND

The present invention relates generally to the field of quantitative investment, and more particularly to a Bilateral Autotrading Framework (BAF) based on Bilateral Loss to forecast the cross-sectional rank of stock return.

Quantitative trading is a computer software-based trading strategy that uses mathematical models and calculations to assess patterns and trends in the movement and behavior of stock prices to pick undervalued stocks at the right time and execute a profitable trade. It is usually based on inputs like price and volume at which they are traded. However, shares often do not have a fixed pattern and have cyclical patterns where quantitative trading techniques help cash in on those trends.

The main aim is to pick underpriced stocks and find assets above their actual worth, eliminating human intervention from investment decision-making. The reason for looking at a computer program-based model is to pick up a trend that a human mind may miss. These trading methods have algorithmic and complex statistical models. They are fast-paced and have short-term trading goals. The quantitative trader is well-versed with numerical tools like moving averages. The traders capitalize on technology and mathematical and statistical models to make sharp trading strategies. Quantitative traders take a trading strategy and build a mathematical model based on historical data.

### SUMMARY

According to one embodiment of the present invention, a computer-implemented method, a computer program product, and a computer system are provided quantitative investment using a bilateral autotrading framework (BAF). A processor receives a market dataset comprising stock prices, constructs a time series input by applying cross-sectional rank forecasting to the market dataset, generates a bilateral indicator based on the time series input, predicts a rank of stock return based on the bilateral indicator, and executes an adjustment of a position in a stock based on the rank of stock return.

### BRIEF DESCRIPTION OF THE DRAWINGS

FIG. 1 depicts a functional block diagram illustrating a quantitative investment environment, in accordance with an embodiment of the present invention;

FIG. 2 is a flowchart depicting operational steps of a quantitative investment program, in accordance with an embodiment of the present invention;

FIG. 3 depicts a schematic representation of a bilateral autotrading framework for stock prediction, in accordance with one embodiment of the present invention; and

FIG. 4 depicts a block diagram of components of a computing device in accordance with an illustrative embodiment of the present invention.

### DETAILED DESCRIPTION

The disclosed embodiments include an approach for improving quantitative trading, where indicator effectiveness continuously plays a vital role in stock prediction. Certain embodiments include systems that construct indicators focused on achieving high Pearson Correlation Coefficient (CORR) with returns. However, the pursuit of high CORR may ignore some indicators that produce high profits. Therefore, embodiments disclosed herein disclose using a Bilateral Correlation Coefficient (BCORR) to detect profitable indicators with low CORR. BCORR is a weighted correlation coefficient, and the weight is a variable related to the return so that the top and bottom ranked returns have a more significant impact on the BCORR. To generate an indicator that has high BCORR with the return, embodiments disclosed below include a Bilateral Autotrading Framework (BAF) based on Bilateral Loss to forecast the cross-sectional rank of stock return, and the prediction is adopted as a bilateral indicator to select stocks to invest. Additionally or alternatively, the positions of the selected stocks may be optimized by the Sharpe-oriented optimization to reduce the risk and improve the return.

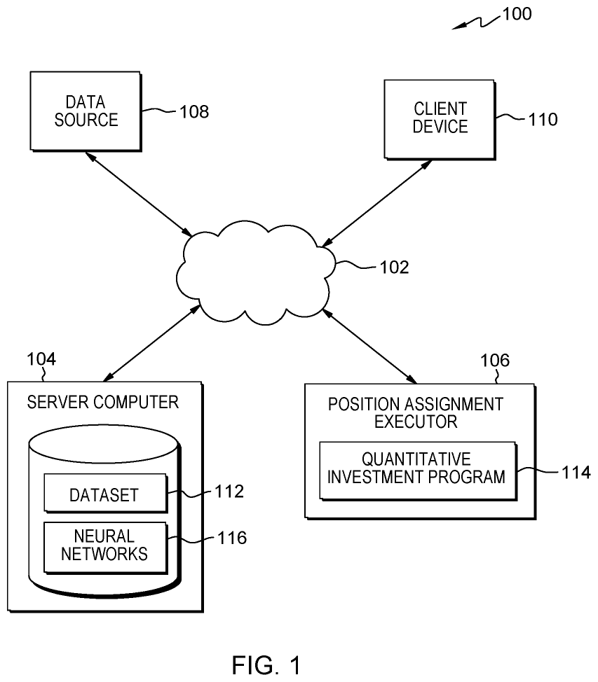

FIG. 1 depicts a functional block diagram illustrating a quantitative investment environment 100, in accordance with one embodiment of the present invention. FIG. 1 provides only an illustration of one implementation and does not imply any limitations regarding the environments in which different embodiments may be implemented. Many modifications to the depicted environment may be made by those skilled in the art without departing from the scope of the invention as recited by the claims.

The quantitative investment environment 100 includes a server computer 104, a position assignment executor 106, a data source 108, and a client device 110 connected over a network 102. The network 102 can be, for example, a telecommunications network, a local area network (LAN), a wide area network (WAN), such as the Internet, or a combination of the three, and can include wired, wireless, or fiber optic connections. The network 102 can include one or more wired and/or wireless networks that are capable of receiving and transmitting data, voice, and/or video signals, including multimedia signals that include voice, data, and video information. In general, the network 102 can be any combination of connections and protocols that will support communications between the server computer 104, the position assignment executor 106, the data source 108, the client device 110, and other computing devices (not shown) within the computational environment 100. In various embodiments, the network 102 operates locally via wired, wireless, or optical connections and can be any combination of connections and protocols (e.g., personal area network (PAN), near field communication (NFC), laser, infrared, ultrasonic, etc.).

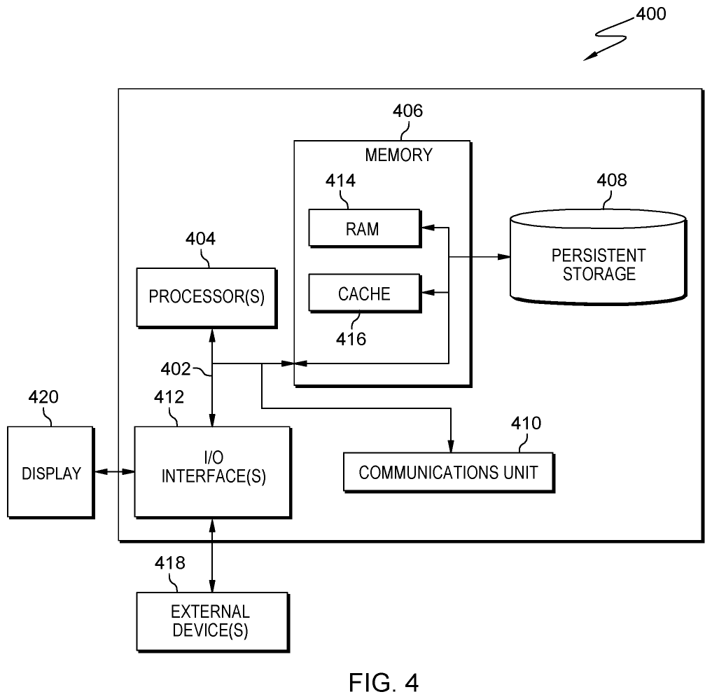

The server computer 104 can be a standalone computing device, a management server, a web server, a mobile computing device, or any other electronic device or computing system capable of receiving, sending, and processing data. In other embodiments, the server computer 104 can represent a server computing system utilizing multiple computers as a server system, such as in a cloud computing environment. In another embodiment, the server computer 104 can be a laptop computer, a tablet computer, a netbook computer, a personal computer (PC), a desktop computer, a personal digital assistant (PDA), a smart phone, or any programmable electronic device capable of communicating with other computing devices (not shown) within the quantitative investment environment 100 via the network 102. In another embodiment, the server computer 104 represents a computing system utilizing connected computers and components (e.g., database server computers, application server computers, etc.) that act as a single pool of seamless resources when accessed within the computational environment 100. In the depicted embodiment, the server computer 104 includes a dataset 112 that may include raw stock price data or volume data of stocks collected from the data source 108. In other embodiments, the server computer 104 may contain other applications, databases, programs, etc. which have not been depicted in the quantitative investment environment 100. The server computer 104 may include internal and external hardware components, as depicted and described in further detail with respect to FIG. 4.

The dataset 112 is a repository for data used by the clustering program 120. In the depicted embodiment, the dataset 112 resides on the server computer 104. In another embodiment, the dataset 112 may reside elsewhere within the quantitative investment environment 100, provided a quantitative investment program 114 has access to the dataset 112. The dataset 112 can be implemented with any type of storage device capable of storing data and configuration files that can be accessed and utilized by the quantitative investment program 114, such as a database server, a hard disk drive, or a flash memory. In an embodiment, the dataset 112 stores a data stream used by the quantitative investment program 114, such as real-time stock prices, stock comparisons, company financial information, or other investment factors. The dataset 112 may more generally contain one or more sets of one or more instances of unclassified data. The server computer 104 may also house neural networks 116 for use by other components of the quantitative investment environment 100.

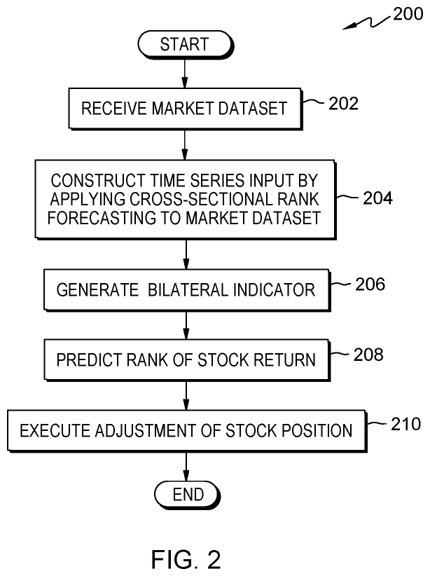

The quantitative investment program 114 is a program for quantitative investment and adjusting positions of a stock. In the depicted embodiment, the quantitative investment program 114 is a standalone software program. In another embodiment, the functionality of the quantitative investment program 114, or any combination programs thereof, may be integrated into a single software program. In some embodiments, quantitative investment program 114 may be located on separate computing devices (not depicted) but can still communicate over the network 102. In various embodiments, client versions of the quantitative investment program 114 may reside on any other computing device (not depicted) within the computational environment 100. The quantitative investment program 114 is depicted and described in further detail with respect to FIG. 2.

FIG. 2 depicts operational procedures of the quantitative investment program 114 of FIG. 1, in accordance with an embodiment of the present invention. The quantitative investment program 114 receives a market data set having a plurality of values, points, vectors, etc. (block 202). The data set may include a variety of types of data from different sources and capturing techniques. The data may be captured in real time and updated with additional data points over time. The market data set may include all of a subsection of the dataset 112 contained in the server computer 104. The quantitative investment program 114 may receive any type of investment data, such as open, close, high, low, volume weighted average price, amount, turnover, market value, price-to-book ratios, price-to-earnings ratios, and price-to-sales ratios, or other market data points.

Once the quantitative investment program 114 has received the relevant data for making investments, the quantitative investment program 114 may next construct one or more time series inputs by applying cross-sectional rank forecasting to the market dataset (block 204). The goal of the quantitative investment program 114 is to generate an indicator based on time series inputs for market trend forecasting. Some data preprocessing techniques are applied to the inputs to construct the time series inputs before feeding them into models that utilize neural networks 116. The most common techniques are de-extremization, neutralization, and normalization. However, these preprocessing methods ignore some essential information in the market. More precisely, de-extremization will lose information in bilaterally extreme points. Longing or shorting stocks based on the indicators' order is more interpretable, so the quantitative investment program 114 applies a cross-sectional rank to preprocess the input features and target returns.

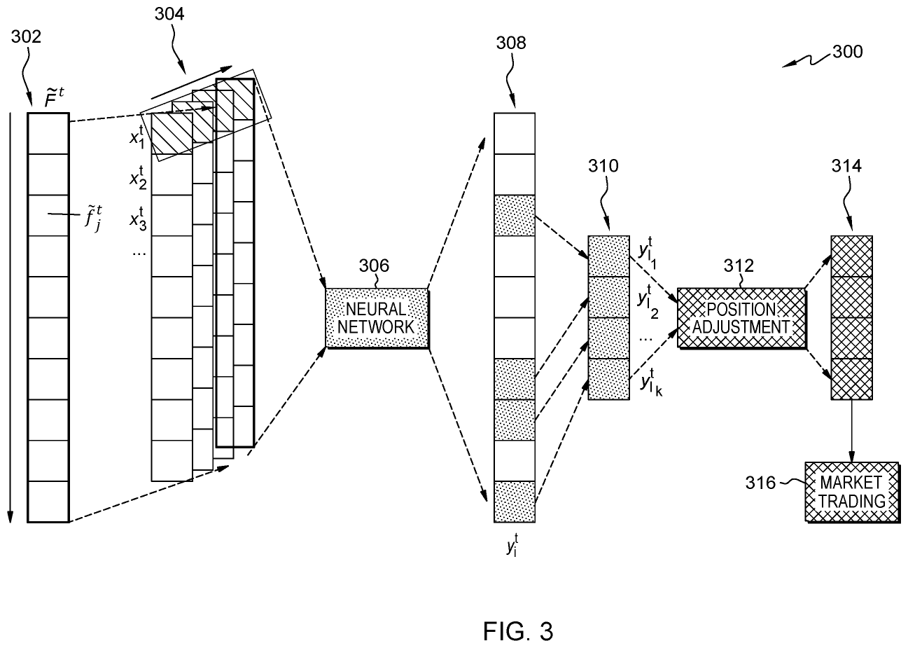

FIG. 3 depicts a schematic representation of a bilateral autotrading framework 300 for stock prediction, in accordance with one embodiment of the present invention. The bilateral autotrading framework 300 receives a market dataset 302 and constructs time series inputs 304 that may include backtracking time units for each new series. The time series inputs 304 are made up of particular stock values at particular times. The quantitative investment program 114 applies a cross-sectional rank of the time series inputs 304 using, for example, a ranking relationship such as:

$${\tilde{F}}^{T} = {[ {\tilde{f}}_{1}^{t} , \tilde{{f}_{2}^{t}} , … {\tilde{f}}_{n}^{t} ]}^{T} \\ where \\ {\tilde{f}}_{j}^{t} = \frac{1}{m} rank ( {f}_{j}^{t} ) , {\tilde{r}}^{t} = \frac{1}{m} rank ( {r}^{t} )$$

and where m is the stock identifying number (e.g., m=1 identifies a first stock, m=2 identifies a second stock) and the rank function computes the numerical data ranks (1 through m) at time t. Furthermore, \tilde{f}ⱼ^{t}∈ [symbol] represents the ranked values of the j^{th} feature at time t; \tilde{F}^{t}∈ [symbol] represents the combined vector of all n features; and \tilde{r}^{t}∈ [symbol] represents the ranked returns at time t. Then, vectors xₘ^{t} of the time series inputs 304 for the i^{th} stock at time t can be constructed as a combination of Ft for all t from 0 to T, with T being the backtracking time units (e.g., the length of each time series input 304).

After the time series inputs 304 are ranked and processed, the quantitative investment program 114 generates a bilateral indicator (block 206). In certain embodiments, generating the bilateral indicator may include using a deep metric learning network comprising bilateral loss. The quantitative investment program 114 may generate the bilateral indicator yᵢ^{t} by feeding each time series input vector xₘ^{t} into a neural network 306. In order to construct a bilateral indicator, the quantitative investment program 114 may use a loss function. For example, the quantitative investment program 114 may use a loss function that magnifies the influence of stocks ranked at the top or the bottom of the time series inputs. Such a loss function may include, for example:

$$ℒ = \frac{1}{mT} {\sum }_{t = 1}^{T} {\sum }_{i = 1}^{m} {( {y}_{i}^{t} - {r}_{i}^{- t} )}^{2} \cdot ln ( \vert {r}_{i}^{- t} - 0.5 \vert + e )$$

Where 0.5 indicates half-way from a bottom rank to a top rank, and thus means that the stocks ranked in the middle get the least attention. This coefficient is an adjust weight for CORR, and could be replaced to any weighting method or kernel function (e.g, Gaussian function following Gaussian distribution). If the rank value of the current sample is 0.5, which means the return ranks in the middle, this sample will have the lowest lambda weight. In certain embodiments, the bilateral indicator may include a Pearson Correlation Coefficient (CORR) score that is less than −0.3 and greater than 0.3. Bilateral loss reduces the regression error of the top or bottom ranked stocks at the cost of increasing the middle-ranked stocks' error. The quantitative investment program 114 may measure the profitability of the bilateral indicators yₗ^{t} by using a bilateral correlation coefficient (BCORR). The bilateral indicators yₗ^{t} and the ranked returns \tilde{r}^{t} are utilized to produce the BCORR, along with the standard deviations of y and r (σ_{y} and σᵣ, respectively). The BCORR generated by performing a bilateral distribution simulation that may be calculated as:

$$\frac{{\sum }_{t = 1}^{T} {\sum }_{i = 1}^{m} {λ}_{1}^{t} ( {y}_{1}^{t} - {μ}_{y} ) ( {r}_{i}^{t} - {μ}_{r} )}{{σ}_{y} {σ}_{r}}$$

With respect to the above equation, X is a parameter reflects the weight of the current sample in relation to the total training samples, and is the average value of y or r. The cross-sectional rank of the return ranking at the top or the bottom will have higher X. The BCORR may also include a weighted correlation coefficient that is impacted more significantly by top and bottom ranked returns. The ranked returns may typically be selected based on proximity to a more central location, but the BCORR highlights selections that may generate high returns while being located near the top and bottom ranked returns.

Using the bilateral indicator, the quantitative investment program 114 predicts a rank 310 of stock returns (block 208). The rank of stock returns are based on the bilateral indicator 308 and may be adjusted using a position adjustment algorithm 312 such as a Sharpe-oriented position algorithm. The Sharpe-oriented optimization algorithm is used to assign positions 314 for the top stocks selected based on the bilateral indicators 308 The position adjustment algorithm 312 may be based on momentum of portfolio performance. For example, stocks that have performed well recently may be assumed to perform well in the future, and therefore given more prominent positions 314 by the position adjustment algorithm 312. Therefore, the positions leading to the best Sharpe ratio in recent time units are adopted as our future positions. The Sharpe ratio of recent time units is calculated based on the position of a particular stock and the portfolio return at a given time. Adding diversification in the positions 314 should increase the Sharpe ratio compared to similar portfolios with a lower level of diversification. The quantitative investment program 114 may assume that risk is equal to volatility, which is not unreasonable but may be too narrow to be applied to all investments. The Sharpe ratio can be used to evaluate the past performance of a stock or a bilateral indicator 308 where actual returns are used in the formula. Alternatively, the quantitative investment program 114 could use expected performance and the expected risk-free rate to calculate an estimated Sharpe ratio.

The quantitative investment program 114 may also execute an adjustment of a position in a stock based on the rank 310 of stock return (block 210). The adjustment of the position may be increased or decreased for a given stock, and may be accomplished by the client devices 110 illustrated in FIG. 1. The adjustment is also represented in FIG. 3 as the component illustrated as market trading 316. The adjustment of the position may be for a set amount of time, or be conditional on other determined factors as determined by the quantitative investment program 114. For example, the quantitative investment program 114 may select the top one hundred stocks to invest in at the opening price and hold the stocks for one day, or ten days, or some other amount of time before selling and adjusting positions in new stocks. The quantitative investment program 114 may also take positions other than direct ownership of a stock based on the rank 310 of the stock return (block 210). For example, if the rank 310 is low, the quantitative investment program 114 may execute an adjustment of a short position for a given stock. Therefore, embodiments disclosed herein include a bilateral autotrading framework that improves a return on investment by incorporating cross-sectional rank forecasting and a bilateral indicator into a market trading program.

FIG. 4 depicts a block diagram of components of a computing device 400 in accordance with an illustrative embodiment of the present invention. As described above, the computing device 400 may represent any of the devices (e.g., server computer 104, position assignment executor 106, data source 108, and client device 110) described above, or a combination of the devices, in the embodiments where the devices are embodied as components of a single computing device 400. It should be appreciated that FIG. 4 provides only an illustration of one implementation and does not imply any limitations with regard to the environments in which different embodiments may be implemented. Many modifications to the depicted environment may be made.

The computing device 400 includes communications fabric 402, which provides communications between RAM 414, cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of computer processor(s) 404 by holding recently accessed data, and data near accessed data, from memory 406.

The software components (e.g., quantitative investment program 114) may be stored in persistent storage 408 and in memory 406 for execution and/or access by one or more of the respective computer processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. The proxy, application, access manager, collection page, authentication tool, or multi-factor authentication page may be downloaded to persistent storage 408 through communications unit 410.

I/O interface(s) 412 allows for input and output of data with other devices that may be connected to the computing device 400. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention (e.g., rule generating program 130) can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for quantitative investment using a bilateral autotrading framework (BAF), comprising:
receiving, by one or more processors, a market dataset comprising stock prices;
constructing, by one or more processors, a time series input by applying cross-sectional rank forecasting to the market dataset;
generating, by one or more processors, a bilateral indicator based on the time series input, wherein the bilateral indicator magnifies influence of stocks ranked at the top and the bottom of the time series input;
predicting, by one or more processors, a rank of stock return based on the bilateral indicator; and
executing, by one or more processors, an adjustment of a position in a stock based on the rank of stock return.

2. The method of claim 1, wherein the time series input comprises backtracking time units.

3. The method of claim 1, wherein executing the adjustment of the position comprises optimizing a Sharpe-oriented position algorithm.

4. The method of claim 1, wherein generating the bilateral indicator comprises using a deep metric learning network comprising bilateral loss.

5. The method of claim 1, wherein generating the bilateral indicator comprises performing a bilateral distribution simulation with a Bilateral Correlation Coefficient (BCORR).

6. The method of claim 5, wherein the bilateral indicator comprises a Pearson Correlation Coefficient (CORR) score that is less than −0.3 and greater than 0.3.

7. The method of claim 5, wherein the BCORR comprises a weighted correlation coefficient that is impacted more significantly by top and bottom ranked returns.

8. A computer program product for quantitative investment using a bilateral autotrading framework (BAF), comprising:
one or more computer readable storage media, and program instructions collectively stored on the one or more computer readable storage media, the program instructions comprising:
program instructions to receive, by one or more processors, a market dataset comprising stock prices;
program instructions to construct a time series input by applying cross-sectional rank forecasting to the market dataset;
program instructions to generate a bilateral indicator based on the time series input, wherein the bilateral indicator magnifies the influence of stocks ranked at the top or the bottom of the time series inputs;
program instructions to predict a rank of stock return based on the bilateral indicator; and
program instructions to execute, by one or more processors, an adjustment of a position in a stock based on the rank of stock return.

9. The computer program product of claim 8, wherein the time series input comprises backtracking time units.

10. The computer program product of claim 8, wherein executing the adjustment of the position comprises optimizing a Sharpe-oriented position algorithm.

11. The computer program product of claim 8, wherein generating the bilateral indicator comprises using a deep metric learning network comprising bilateral loss.

12. The computer program product of claim 8, wherein generating the bilateral indicator comprises performing a bilateral distribution simulation with a Bilateral Correlation Coefficient (BCORR).

13. The computer program product of claim 12, wherein the bilateral indicator comprises a Pearson Correlation Coefficient (CORR) score that is less than −0.3 and greater than 0.3.

14. The computer program product of claim 12, wherein the BCORR comprises a weighted correlation coefficient that is impacted more significantly by top and bottom ranked returns.

15. A computer system quantitative investment using a bilateral autotrading framework (BAF), comprising:
one or more computer processors, one or more computer readable storage media, and program instructions collectively stored on the one or more computer readable storage media for execution by at least one of the one or more computer processors, the program instructions comprising:
program instructions to receive, by one or more processors, a market dataset comprising stock prices;
program instructions to construct a time series input by applying cross-sectional rank forecasting to the market dataset;
program instructions to generate a bilateral indicator based on the time series input, wherein the bilateral indicator magnifies the influence of stocks ranked at the top or the bottom of the time series inputs;
program instructions to predict a rank of stock return based on the bilateral indicator; and
program instructions to execute, by one or more processors, an adjustment of a position in a stock based on the rank of stock return.

16. The computer system of claim 15, wherein the time series input comprises backtracking time units.

17. The computer system of claim 15, wherein executing the adjustment of the position comprises optimizing a Sharpe-oriented position algorithm.

18. The computer system of claim 15, wherein generating the bilateral indicator comprises using a deep metric learning network comprising bilateral loss.

19. The computer system of claim 15, wherein generating the bilateral indicator comprises performing a bilateral distribution simulation with a Bilateral Correlation Coefficient (BCORR).

20. The computer system of claim 19, wherein the BCORR comprises a weighted correlation coefficient that is impacted more significantly by top and bottom ranked returns.
